(19) United States
(12) Patent Application Publication
(10) Pub. No.: US 2026/0239186 A1
(43) Pub. Date: Aug. 13, 2026

(54) SLICE AWARE NETWORK SELECTION

(71) Applicant: INTERDIGITAL PATENT HOLDINGS, INC., Wilmington (DE)

(72) Inventors: Anuj Sethi, Ottawa (CA); Michael Starsinic, Newtown, PA (US); Saad Ahmad, Montreal (CA); Ulises Olvera-Hernandez, Saint-Lazare (CA); Samir Ferdi, Kirkland (CA)

(73) Assignee: INTERDIGITAL PATENT HOLDINGS, INC., Wilmington (DE)

(21) Appl. No.: 19/473,023

(22) PCT Filed: Mar. 26, 2024
(86) PCT No.: PCT/US2024/021491

§ 371 Date: Oct. 6, 2025

Related U.S. Application Data
(60) Provisional application No. 63/457,173, filed on Apr. 5, 2023.

(51) Int. Cl. H04W 48/18; H04W 48/16; H04W 84/04

(52) U.S. Cl. CPC H04W 48/18; H04W 48/16; H04W 84/04

(57) ABSTRACT

A method performed by a WTRU includes receiving a first list, the first list comprising a network slice-set of preferred PLMNs or SNPNs, the first list associated with one or more SNSSAI and PLMN/SNPN prioritization information, receiving an allowed NSSAI list that does not include a first S-NSSAI in the first list, detecting an event associated with the first S-NSSAI, the event comprising one of (i) a detection that uplink application traffic is associated with the first S-NSSAI that is not part of the allowed NSSAI list, or (ii) sending a PDU Session Request that includes the first S-NSSAI and receiving a PDU Session Rejection message or receiving an indication that the first S-NSSAI is a rejected S-NSSAI, selecting a PLMN/SNPN among multiple PLMN/SNPNs on the first list, and registering with the selected PLMN/SNPN and sending a requested NSSAI list that includes at least the first S-NSSAI.

### CROSS REFERENCE TO RELATED APPLICATIONS

This application claims the benefit of U.S. provisional patent application No. 63/457,173 filed 5 Apr. 2023 which is incorporated by reference herein in its entirety.

### BACKGROUND

Discussed herein are 5G System enhancements on the reception of the newly defined Slice-aware steering of roaming (SoR) information and its handling for cases e.g., multiple slices with slice-aware information are needed by user equipment (UE), UE camped on a lower priority public land mobile network (PLMN) for a particular slice, handling of forbidden lists if PLMN/SNPNs (stand alone non-public network) are present in both slice-aware SoR information as well as the forbidden lists, extension of slice-aware SoR to SNPNs/Hosting networks.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 depicts a signal flow diagram of network selection and reselection based on priority;

FIG. 3 depicts a signal flow diagram of a slice-aware SoR information for PLMNs/SNPNs/Hosting networks; and

FIG. 4 depicts an example method performed by a WTRU according to aspects of the disclosure.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

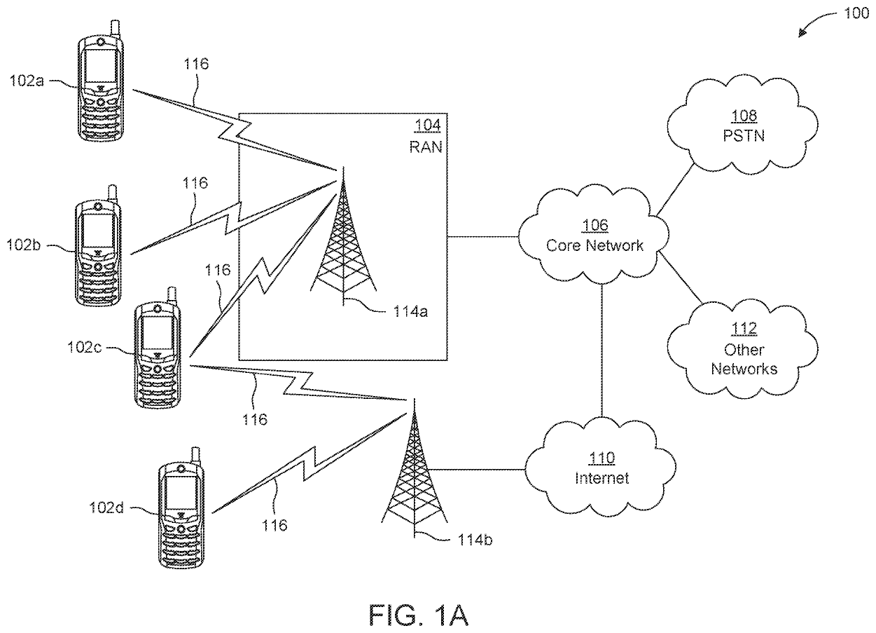

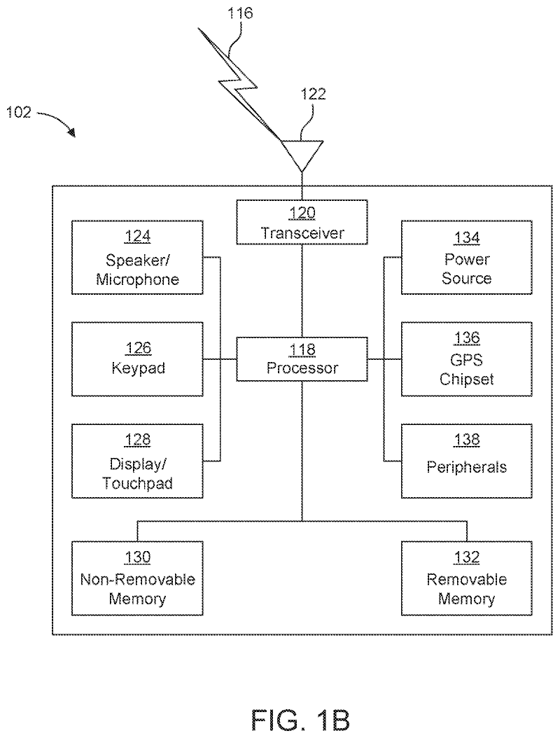

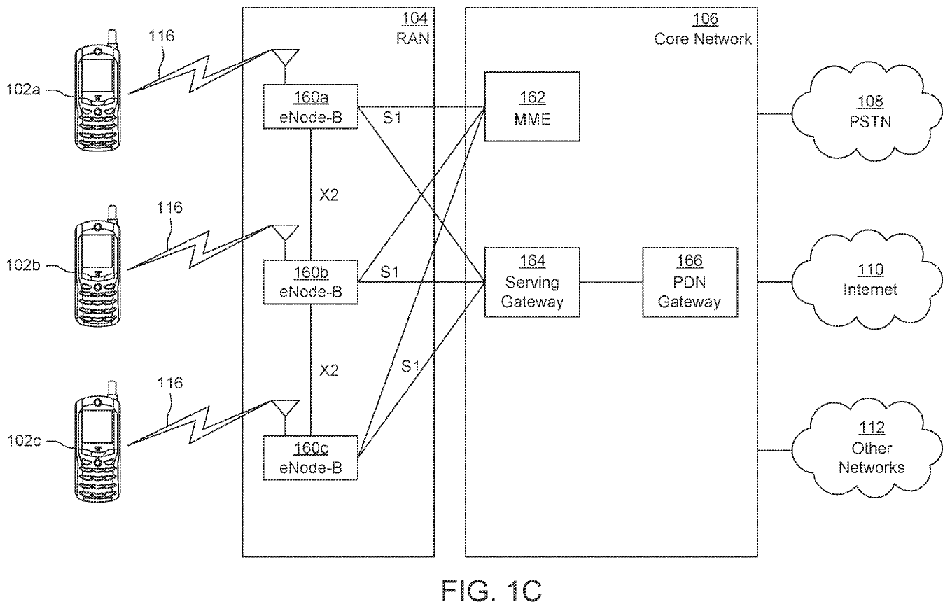

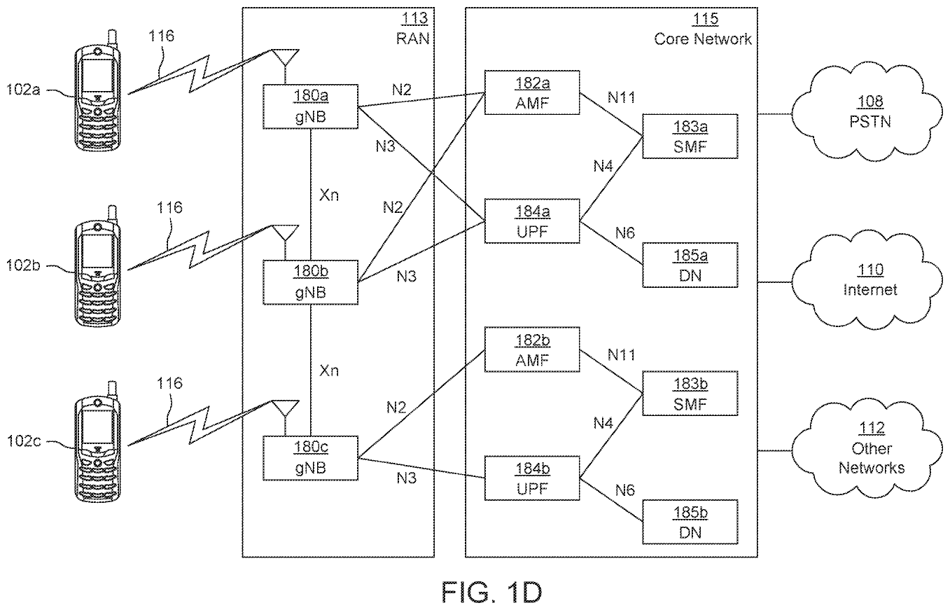

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IOT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an SI interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating user equipment (UE) IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Examples provided herein do not limit applicability of the subject matter to other wireless technologies, e.g., using the same or different principles as may be applicable.

As explained herein, a wireless transmit/receive unit (WTRU) may be an example of a user equipment (UE). Hence the terms UE and WTRU may be used with equal scope herein.

### Description

### Background

A registration area (RA) is a set of tracking areas (TAs). A RA is defined by a tracking area identity (TAI) List (i.e., a list of tracking areas). When the UE registers with the network (i.e., sends a registration request to an AMF), the AMF allocates registration area (i.e. the set of tracking areas in TAI List) to the UE and may take information such as the UE's expected mobility pattern when allocating the TAI list.

A configured network slice selection assistance information (NSSAI) is a list, or collection, of slices that a UE may access. The UE may receive a configured NSSAI in a Registration Accept or UE Configuration Update message.

A Requested NSSAI is a list, or collection, of slices that a UE sends to the network in order to request to register with the slices in the list. The UE may send a Requested NSSAI to the network in a Registration Request message.

An Allowed NSSAI is a list, or collection, of slices that a UE may access in the UE's registration area. In other words, it is a list of slices that the UE may use in the UE's registration area.

A rejected single network slice selection assistance information (S-NSSAI) is an information element that the network may send to a UE in a Registration Accept or a UE Configuration Update message. A rejected S-NSSAI may be a slice that the UE included in a Requested NSSAI, but the network determined the UE may not access.

In this description, the phrases “attempting to register with a slice” and “including a slice (i.e., S-NSSAI) in a Requested NSSAI” are used interchangeably. Herein the terms slice and S-NSSAI are used interchangeably.

In one aspect, S-NSSAIs that the UE provides in the Requested NSSAI which are neither in the Allowed NSSAI nor provided as a rejected S-NSSAI, shall, by the UE, not be regarded as rejected, i.e. the UE may request to register these S-NSSAIs again next time the UE sends a Requested NSSAI.

When a UE is registered to a slice, it uses at least some minimal resources of the slice. For example, the UE will at least send periodic NAS messages to the AMF which is part of the slice. However, the UE may, or may not, use the user plane resources of the slice or other resources of the slice such as SMS and Location Services.

### Triggers for Network Slice Registration

A UE may select up to 8 slices (i.e. S-NSSAIs) from its Configured NSSAI to register to. When a UE selects a slice(s) to register to, the UE will send a Registration Request to the network and the Requested NSSAI information element of the Registration Request will include the slice(s) that were selected for registration.

Various events may trigger the UE to send a register to a slice, Examples of triggers for PDU registration are:

First, the UE may be configured to always attempt register to certain slice(s) unless the UE knows that the slice is not available. For example, the UE may attempt to register to certain slice(s) immediately, or shortly after, power up.

Second, the UE may be configured to attempt to register to certain slice(s) when registering in certain PLMNs.

Third, the UE may be configured to attempt to register to certain slice(s) when certain application traffic starts.

Fourth, the UE may be configured to attempt to register to certain slice(s) when the UE is in a certain location.

Fifth, the UE may be configured to attempt to register to certain slice(s) when certain applications are installed.

Sixth, the UE may be configured to attempt to register to certain slice(s) when prompted by a user interface such a graphical user interface GUI. For example, a user may indicate, via GUI, that a certain service is desired.

### Triggers for Pdu Session Establishment

Once a UE is registered to a slice, it may determine to establish a PDU Session in the slice. A UE may establish a PDU Session by sending a PDU Session Establishment Request to the network. A PDU Session Establishment Request is a NAS-SM message that is sent to an SMF of the network slice that is associated with a network slice.

The PDU Session Establishment Request may include an S-NSSAI that is associated with the PDU Session and a data network name (DNN) that is associated with the PDU Session. If an S-NSSAI is not included in the PDU Session Establishment Request, then the network may determine an S-NSSAI for the PDU Session. If a DNN is not included in the PDU Session Establishment Request, then the network may determine an DNN for the PDU Session.

Various events may trigger the UE to send a PDU Session Establishment Request to the network. Examples of triggers for PDU Session Establishment are:

First, a UE hosted application may request that the UE establish a PDU Session. The request from the UE hosted application may include a DNN and S-NSSAI and the UE may send the same DNN and S-NSSAI to the network in the PDU Session Establishment Request. For example, a UE that is hosted in terminal equipment (TE) part of the UE may invoke an Attention (AT) Command such as +CGDCONT to request that the mobile terminal (MT) part of the UE send a PDU Session Establishment Request to the network.

Second, a UE hosted application may generate uplink traffic that causes the UE to evaluate user route selection policy (URSP) rules in order to determine desired characteristics for a PDU Session that will be used to send the uplink traffic to the network. The result of URSP evaluation may be that the UE determines to use an existing PDU Session or a new PDU Session to send the uplink traffic to the network. If the UE determines to establish a new PDU Session, then it will send a PDU Session Establishment Request to the network. The URSP Rules may also be used to determine what data network name (DNN) and S-NSSAI to include in the PDU Session Establishment Request Third, a UE may be configured with DNN/S-NSSAI combinations and the UE may always establish a PDU Session towards these DNN/S-NSSAI combinations when the UE is registered to the S-NSSAI in the combination. The UE may choose to establish these PDU Session(s) even if there are no UE Applications that will use the PDU Session(s) to send or receive traffic.

Fourth, the UE may receive device trigger that triggers the UE to establish a PDU Session. The device trigger may be a NAS or SMS message. The device trigger message may include the DNN and/or S-NSSAI that the UE should include in the PDU Session Establishment Request.

### Network Slice Admission Control Function (nsacf)

The Network Slice Admission Control Function (NSACF) monitors and controls the number of registered UEs per network slice and/or the number of PDU Sessions per network slice for the network slices that are subject to Network Slice Admission Control (NSAC). The NSACF is configured with the maximum number of UEs and/or the maximum number of PDU Sessions allowed to be served per S-NSSAI subject to NSAC. The NSACF is also configured with information indicating applicable access type(s) for the S-NSSAI (i.e. 3GPP Access Type, Non-3GPP Access Type, or both).

The NSACF keeps track of the current number of UEs registered for a network slice so that it can ensure it does not exceed the maximum number of UEs allowed to register with the network slice.

The AMF triggers a request to NSACF for NSAC for maximum number of UEs when the UE's registration status for a network slice subject to NSAC is changing, i.e. during the UE Registration procedure, the UE Deregistration procedure, the Network Slice-Specific Authentication and Authorization procedure, the AAA Server triggered Network Slice-Specific Re-authentication and Re-authorization procedure, the AAA Server triggered Slice-Specific Authorization Revocation procedure, and/or the UE Configuration Update procedure.

When the maximum number of registrations for a slice has been reached, the NSACF may indicate to the AMF that a request to register to a slice should be rejected and a cause code may be provided to the UE that indicates that the slice registration was rejected because the maximum number registrations for the slice has been reached. A back-off timer may also be sent to the UE and the back-off timer may be used by the UE to detect when the UE may again try to register to the slice.

The NSACF keeps track of the current number of PDU Sessions per network slice so that it can ensure it does not exceed the maximum number of PDU session allowed to be served by the network slice. When an event related to a UE causes the current number of PDU sessions established within the network slice is to increase, the NSACF checks whether the maximum number of PDU sessions per network slice for that network slice has already been reached and if it has, the NSACF applies admission control policies.

When the maximum number of PDU Sessions for a slice has been reached, the NSACF may indicate to the SMF that a PDU Session Establishment Request should be rejected, and a cause code may be provided to the UE that indicates that the PDU Session was rejected because the maximum number of PDU Sessions for the slice has been reached. A back-off timer may also be sent to the UE and the back-off timer may be used by the UE to detect when the UE may again try to establish a PDU Session in the slice.

The anchor SMF triggers a request to NSACF for maximum number of PDU sessions per network slice control during PDU session establishment/release procedures.

### Non Public Networks (npn)

A Non-Public Network (NPN) is a 5GS deployed for non-public use. An NPN is either: a Stand-alone Non-Public Network (SNPN), i.e. operated by an NPN operator and not relying on network functions provided by a PLMN, or a Public Network Integrated NPN (PNI-NPN), i.e., a non-public network deployed with the support of a PLMN.

A non-public network (NPN) is intended for the use of a private entity such as an enterprise or a factory. A SNPN can be identified by a combination of PLMN ID and Network Identifier (NID), where the PLMN ID may be e.g. reserved PLMN IDs for private networks (e.g., with Mobile Country Code=999).

The architecture of a 5G SNPN is based on the architecture of 5G System. The NG-RANs of the SNPN broadcasts the combination of PLMN IDs and NIDs. A UE operating in SNPN access mode reads the broadcast system information for available (PLMN ID+NID)'s and selects the SNPN for which it has subscription and credentials.

### Public Network Integrated Non-Public Network (PNI-NPN)

A PNI-NPN is a Non-Public Network made available using PLMN infrastructure/resources, e.g., a PLMN network slice. A group of PLMN users which are allowed to access a certain PNI-NPN is referred to as a Close Access Group (CAG) and a CAG is identified by a CAG identifier. CAG users can only access a PNI-NPN from a cell that supports CAG access, which is called a “CAG cell”. A CAG cell broadcasts a list of CAG identifiers that it supports. A CAG UE is configured by the network with a list of CAGs that it can access (Allowed CAG List). When a CAG UE detects a CAG cell, it can only select/access the CAG cell if at least one of the broadcasted CAG identifier(s) matches one of the CAG identifiers in its Allowed CAG List.

### 5G Networks Providing Access to Localized Services (PALS Network)

In some circumstances, a small cellular network may be deployed to provide services to local users within a certain area. For example, a temporary non-public cellular network may be set up to provide a streaming video service to the audience in a live concert or a football match. For another example, in places like airports, shopping malls and school campuses, where a large crowd may gather, small cellular networks may be deployed to provide localized services, such as commercial ads in the shopping mall. The services provided by these small cellular networks have two basic characteristics: first, the services are localized, meaning that they are related to the activities/events in a certain spot or area, and are usually limited to the users within the area; second, the users don't utilize these services on a regular basis but most likely in on-demand or temporary fashion.

A 5G system may be enhanced to provide such localized services and enable users to access the hosting network that provides those services. Those localized services are referred to as “PALS service” or “localized services”, and the network that provides PALS services are referred to as “PALS network” or “PALS hosting network” or simply “hosting network”.

A hosting network may be a Standalone Non-Public Network (SNPN), or a Public Network Integrated Non-Public Network (PNI-NPN), or a PLMN. The local service provider may be the hosting network operator or a 3rd party service provider.

### Issues Addressed

A service providing visited PLMN (VPLMN) network slice information to a roaming UE has the following service requirements.

For a roaming UE activating a service/application requiring a network slice not offered by the serving network but available in the area from other network(s), the home PLMN (HPLMN) can be able to provide the UE with prioritization information of the VPLMNs with which the UE may register for the network slice.

The above issue aims at addressing the following aspects for a roaming UE requiring a network slice not offered by higher priority VPLMN(s) but available from other network(s):

How and when the HPLMN provides the UE with information about slice availability per VPLMN and prioritization information of the VPLMNs with which the UE may register for the network slice. The study includes the content of the information.

How and when to use the information received by the UE from the HPLMN to influence automatic PLMN selection.

The above issue only considers the network selection procedure for the 3GPP access type.

The following principles may be assumed.
1. A slice based SoR mechanism to deliver enhanced slice-aware SoR information will reuse the current SoR mechanism for SoR information delivery.
2. The SoR container (which is used also to carry the enhanced slice-aware SoR information) from the unified data management (UDM) to the UE is security protected.
3. UDM requires knowing the support of the enhanced SoR information by the UE to deliver the enhanced slice-aware SoR information to the UE. A UE may provide additional assistance information. Any UE assistance information may be transparently forwarded by UDM to SoR-AF during the triggering procedure by UDM. The SoR-AF should not attempt to fetch any assistance information if not provided by the UE. UE assistance information can either implicitly or explicitly indicate that the UE supports slice based SoR feature.
4. Only a UE supporting slice based SoR feature can receive the enhanced slice-aware SoR information via UDM, the enhanced slice aware information include preferred PLMNs for specific S-NSSAIs in the UE subscription (a preferred PLMN list may be also be a single PLMN that is known by HPLMN to support the S-NSSAI, or a list of PLMNs in preference order that differs from the order of the basic SoR information that is also provided).
5. The UE will perform the PLMN selection based on the received enhanced slice-aware SoR information.
6. As for the current SoR information, It may be possible for the HPLMN to update the enhanced slice-aware SoR information when it is required by HPLMN, e.g., change in the UE subscription or other HPLMN trigger.
7. The SoR AF can take into account Subscribed S-NSSAIs of the UE. The SOR AF can get Subscribed S-NSSAIs using existing UDM services. This can also be used to generate enhanced slice-aware SoR information and legacy SoR information. In one implementation, the HPLMN may provide the slice aware SoR information to the roaming UE's which may include preferred PLMNs for specific S-NSSAIs in the UE subscription.

### Issue #1

### The UE Wants to Access Multiple Slices and a Different PLMN is Preferred for Each Slice

Consider a scenario where S-NSSAI-1 has priority PLMN-1 and S-NSSAI-2 has priority PLMN-2, and if the UE intends to use both S-NSSAIs i.e., S-NSSAI-1 and S-NSSAI-2. In such a scenario, a method is desired for how the UE may determine which PLMN to prioritize (i.e., PLMN-1 or PLMN-2).

### Issue #2

### Handling of Priority Selection for PLMNs/SNPNs for Slice-Aware Slices

The UE may be configured with information about PLMNs that should be prioritized when accessing certain PLMNs. In order to deal with scenarios where the UE is camped on a PLMN that is relatively low in priority for one of the slices that it is accessing, methods are desired for determining when to trigger PLMN re-selection.

### Issue #3

### Handling of Forbidden Lists on Reception of Slice-Aware SoR Information

The UE may be configured with information about PLMNs that should be prioritized when accessing certain network slices (S-NSSAI). One or more of the PLMNs that are associated with a slice may also be in a forbidden list that is maintained by the UE. Methods are desired for how the UE should determine whether the PLMN should be prioritized or considered forbidden.

### Issue #4

### Provisioning of the Slice Aware SoR Information to the SNPNs/Hosting Network

Methods are desired to support a requirement on enhancing the information available to the UE in roaming scenarios regarding the availability of network slices in VPLMNs available in the roaming country, in order to allow the UE to select and obtain services from the VPLMN supporting the network slices which UE may wish to use for UE's operating in SNPNs/Hosting Networks.

### Proposed Solution to Issue #1

### Issue #1: The UE Wants to Access Multiple Slices and a Different PLMN is Preferred for Each Slice

The following solutions describe how to handle slice-sets based list of preferred PLMNs for cases when more than one Slice has slice aware information and UE needs to use some or all or few of them.

HPLMN/UDM could provide the UE with the slice-sets based list of preferred PLMNs. In an example scenario UDM would provide the UE with slice set which will consist of S-NSSAI-1 and S-NSSAI-2 and corresponding list of preferred PLMNs/SNPNs. The list may include information (e.g., a flag) to indicate whether an S-NSSAI is subject Network Slice Specific Authentication in a particular PLMN/SNPN. Based on the selected slice-sets, the UE could decide on the priorities of the network (PLMN/SNPN) for selection.

HPLMN/UDM could provide the UE with the list of prioritized subscribed S-NSSAIs, this information will assist the UE with network selection when multiple S-NSSAI are needed. In the scenario where S-NSSAI-1 and S-NSSAI-2 are both needed by UE and they have different priority PLMNs, the higher priority S-NSSAI will be used to select the priority of the PLMN Alternatively, or additionally, the UE could determine a list of prioritized subscribed S-NSSAIs or modify the list of prioritized subscribed S-NSSAIs that is provided by the HPLMN.

If the UE determines the list of prioritized subscribed S-NSSAIs, the UE may choose to initially include only slices from the Configured NSSAI in the list.

If the UE receives the list of prioritized subscribed S-NSSAIs from the HPLMN, the UE may choose to modify the list so that S-NSSAIs from Configured NSSAI are always prioritized over S-NSSAIs that are not in the Configured NSSAI.

The UE may choose to modify the list by increasing the priority of any S-NSSAI that is associated with an established PDU Session.

The UE may choose to modify the list by increasing the priority of any S-NSSAI that is associated with a PDU Session Establishment Reject Message.

The UE may choose to modify the list by increasing the priority of any S-NSSAI that is associated with application traffic and where the UE has determined, based on URSP Rule evaluation, that there is no suitable Established PDU Session that can carry the application traffic and no new PDU Session can be established to carry the application traffic.

The UE may choose to modify the list by increasing or decreasing the priority of any S-NSSAI that is subject to Network Slice Specific Authentication in a particular PLMN/SNPN.

The UE may select first VPLMN (e.g., a priority). The UE may request from the network an S-NSSAI based on an application trigger. The UE may receive a response wherein the S-NSSAI is rejected in the PLMN. The UE may keep information about the needed slice and use that along available slice aware PLMN information provided by HPLMN, when initiating a slice aware PLMN selection.

Alternatively in the case of the scenario presented herein, the UE could use defined prioritized lists for PLMN/SNPN/Hosting Networks selection to resolve the conflict on which PLMN/SNPN should be given preference for network selection.

The UE will pick a higher priority PLMN/SNPN/Hosting Network which supports all the UE selected slices (e.g. S-NSSAI-1 & S-NSSAI-2) and try registration, if registration is not successful, the UE will move onto the next available network satisfying the conditions for slices in priority order.

For example, the network selection lists used for selection in priority order (first entry has the highest priority) are as follows: (1) User Controlled PLMN Selector with Access Technology [for PLMNs]. (2) Operator Controlled PLMN (OPLMN) Selector with Access Technology [for PLMNs]. (3) User controlled prioritized list of preferred SNPNs (in priority order) [for SNPNs]. (4) Credentials holder controlled prioritized list of preferred SNPNs (in priority order) [for SNPNs]. (5) Credentials holder controlled prioritized list of GINs (in priority order) [for SNPNs]. (6) User controlled prioritized list of preferred SNPNs (in priority order) with validity conditions (Hosting Networks) (for Hosting Networks). (7) Credentials holder controlled prioritized list of preferred SNPNs (in priority order) with validity conditions (for Hosting Networks). (8) Credentials holder controlled prioritized list of GINs (in priority order) with validity conditions (for Hosting Networks).

In case available PLMNs/SNPNs/Hosting Networks are not part of any of the lists, then they shall be selected based on the signal strength, the highest signal strength network will have the highest priority.

In summary, addressing Issue #1, the UE wants to access multiple slices and a different PLMN is preferred for each slice. In the solution to Issue #1, the UE may perform the following:
a. The UE receives a first list, the list is associated with one or more S-NSSAI(s) and PLMN prioritization information. The list may be called slice-sets based list of preferred PLMNs. The UE may receive multiple lists (e.g., one for each combination of S-NSSAI(s) that it may access).
b. The UE receives an Allowed NSSAI that does not include a first S-NSSAI
c. The UE detects an event that is associated with the first S-NSSAI, the event may be: (i) Detecting that uplink application traffic is associated with the first S-NSSAI and that the first S-NSSAI is not part of the Allowed NSSAI, or (ii) Sending a PDU Session Establishment Request that includes the first S-NSSAI and receiving a PDU Session Establishment Rejection message. The UE may be receiving an indication that the first S-NSSAI is a rejected S-NSSAI or partially rejected S-NSSAI.
d. Based on detecting the event, perform a PLMN selection procedure to select one PLMN among multiple PLMNs, wherein the selection is based on the prioritization information from the list.
e. Register with the selected PLMN and send a Requested NSSAI that includes at least the first S-NSSAI.

The UE may also determine a second list, the second list indicates how to prioritize multiple S-NSSAI.
a. The second list may be called list of prioritized subscribed S-NSSAIs
b. The second list can be the list of prioritized subscribed S-NSSAIs that are received from the UDM/UDR (unified data repository).
c. The second list can be a modified version of a list of prioritized subscribed S-NSSAIs that is received from the UDM/UDR.

The selection step in the PLMN selection procedure may be based on both the prioritization information from the first list and the second list.
a. HPLMN/UDM could provide the UE with the slice-sets based list of preferred PLMNs. In the example scenario, the UDM would provide the UE with slice set which will include S-NSSAI-1 and S-NSSAI-2 and corresponding list of preferred PLMNs/SNPNs. Based on the selected slice-sets, the UE could decide on the priorities of the network (PLMN/SNPN) for selection.
b. HPLMN/UDM could provide the UE with the list of prioritized subscribed S-NSSAIs, this information will assist the UE with network selection when multiple S-NSSAI are needed. In the scenario where S-NSSAI-1 and S-NSSAI-2 are both needed by UE and they have different priority PLMNs, the higher priority S-NSSAI will be used to select the priority of the PLMN.
c. Alternatively, or additionally, the UE could determine a list of prioritized subscribed S-NSSAIs or modify the list of prioritized subscribed S-NSSAIs that is provided by the HPLMN. Options may include: (1) If the UE determines the list of prioritized subscribed S-NSSAIs, the UE may choose to initially include only slices from the Configured NSSAI in the list. (2) If the UE receives the list of prioritized subscribed S-NSSAIs from the HPLMN, the UE may choose to modify the list so that S-NSSAIs from Configured NSSAI are always prioritized over S-NSSAIs that are not in the Configured NSSAI. (3) The UE may choose to modify the list by increasing the priority of any S-NSSAI that is associated with an established PDU Session. (4) The UE may choose to modify the list by increasing the priority of any S-NSSAI that is associated with a PDU Session Establishment Reject Message. (5) The UE may choose to modify the list by increasing the priority of any S-NSSAI that is associated with application traffic and where the UE has determined, based on URSP Rule evaluation, that there is no suitable Established PDU Session that can carry the application traffic and no new PDU Session can be established to carry the application traffic. d. Alternatively the UE could use defined prioritized lists for PLMN/SNPN/Hosting Networks selection to resolve the conflict on which PLMN/SNPN shall be given preference for network selection. Options Include: (1) User Controlled PLMN Selector with Access Technology. (2) Operator Controlled PLMN Selector with Access Technology. (3) User controlled prioritized list of preferred SNPNs (in priority order). (4) Credentials holder controlled prioritized list of preferred SNPNs (in priority order) (5) Credentials holder controlled prioritized list of GINs (in priority order). (6) User controlled prioritized list of preferred SNPNs (in priority order) with validity conditions (Hosting Networks) (7) Credentials holder controlled prioritized list of preferred SNPNs (in priority order) with validity conditions (Hosting Networks). (8) Credentials holder controlled prioritized list of GINs (in priority order) with validity conditions (Hosting Networks).

### Proposed Solution to Issue #2

### Handling of Priority Selection for PLMNs/SNPNs/Hosting Networks for Slice-Aware Slices

In one implementation, the HPLMN may provide the slice-aware SoR information to the roaming UE's which would include preferred PLMNs for specific S-NSSAIs in the UE subscription.

The UE can ensure that during the initial cell selection process at power on or recovery from lack of coverage it shall always try to select the highest priority network for the selected slice(s) (e.g., S-NSSAI-1) as per the received slice-aware SoR Information, in case the highest priority network is not available, the UE shall camp on the lower priority network in the priority order of availability. The selected slice(s) may be a subset of slices that are listed in a Configured NSSAI. The UE may determine the selected slice(s) based on configuration.

UE can make periodic attempts to look for the highest priority network and if available, shall make an attempt to register with it.

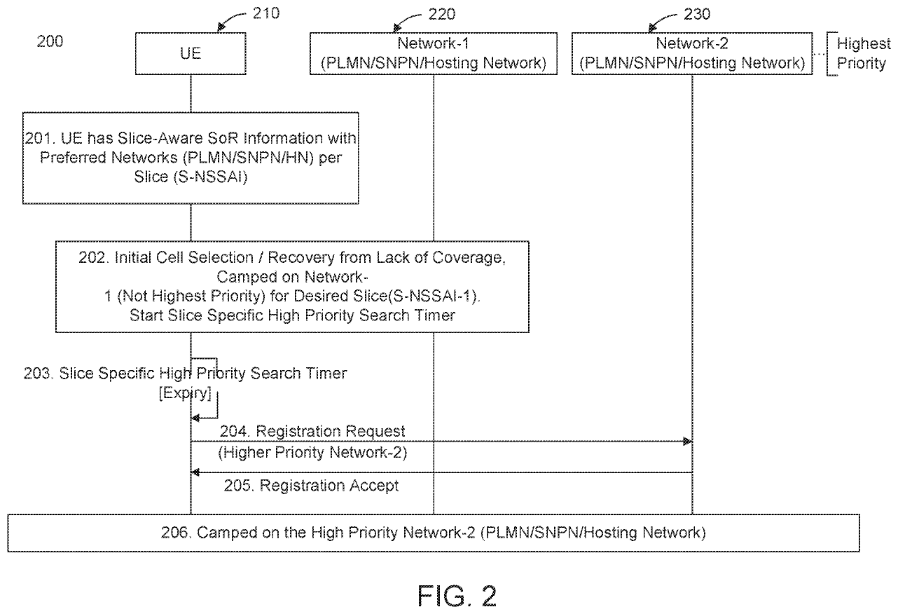

FIG. 2 Provides an example signal flow diagram 200 of a network selection and reselection based on priority.

In FIG. 2 at step 201, the UE (210) has slice-aware SoR information with preferred networks per slice (S-NSSAI). This information is either pre-configured, provided by Home or visiting networks. The information about slice(s) needed, or prioritized, by the UE may be determined based on a prior request from a (e.g., last) serving PLMN, where the slice(s) was rejected in the PLMN or it could be provided by the application running on the UE.

At step 202, upon power on or recovery from loss of coverage, the UE does the initial scan for available Networks to try to select the best (highest priority) network if available i.e., in this scenario only available network is Network-1 (220), which is not the highest priority as per the UE slice-aware SoR information. As the UE is not camped on the highest priority network, it would start a periodic search timer (Slice Specific High Priority Search Timer) to look for higher priority networks.

At step 203, the Slice Specific High Priority Search Timer duration can be either configured in universal integrated circuit card with subscriber identity module (USIM), provided by the network via NAS signaling.

At expiry of the periodic search timer (Slice Specific High Priority Search Timer), the UE would trigger search for higher priority networks, this time around the UE is able to find Network-2 which has a higher priority as compared to currently registered Network-1.

The UE shall ensure that the search for the higher priority network is only triggered in Idle mode, and there are no active data connections/emergency sessions ongoing. In case at expiry of the periodic search timer (Slice Specific High Priority Search Timer), the UE is not in the state to carry out network search, it shall restart the timer and delay the procedure till next expiry.

At step 204, the UE is now camped on Network-2 (230), and sends a REGISTRATION REQUEST to the Network-2.

At step 205, the registration procedure is successful, REGISTRATION ACCEPT sent by the 5G core network.

At step 206, the UE is now camped on the highest priority Network i.e., Network-2, As the UE is camped on the highest priority network it would not start the periodic search timer (Slice Specific High Priority Search Timer).

In summary, addressing Issue 2: the UE may handle priority selection for PLMNs/SNPNs/Hosting Networks for slice-aware slices. In the solution to Issue #2, the UE may perform the following.

Steps for the UE may include: First, the UE receives and stores slice-aware SoR information. The slice-aware SoR information identifies networks that are preferred for accessing one or more S-NSSAI(s). The networks are identified in priority order from highest to lowest.

Second, the UE determines that an S-NSSAI is preferred for access. The determination is based on receiving a message that S-NSSAI is a rejected S-NSSAI or based on information from an application.

Third, the UE performs a network selection procedure that is based networks that were identified in the SoR information as being associated with the S-NSSAI that is preferred for access. The network selection procedure may result in selection of a network that is not the highest priority network for accessing the S-NSSAI that is preferred for access. The UE camps on the selected network.

Fourth, on the condition that UE is not camped on the highest priority network, the UE can start a slice specific periodic search timer (Slice Specific High Priority Search Timer) to look for higher priority networks.

Fifth, the UE can make periodic attempts at expiry of timer (Slice Specific High Priority Search Timer) to look for the higher priority networks for accessing the S-NSSAI and if available, shall make an attempt to register with the higher priority network.

### Proposed Solution to Issue #3

### Handling of Forbidden Lists on Reception of Slice-Aware SoR Information

On reception of the slice-aware SoR information it could happen the provided prioritized PLMNs/SNPNs/Hosting Networks associated with the network slices are part of the forbidden lists maintained by the UE, if this were the case this would result in unwanted results with respect to the network selection and eventually UE might end up with not a preferred PLMN/SNPN/Hosting Network as expected by the UDM/Home Network for the desired network slices.

On reception of the slice-aware SoR information the UE shall remove the networks provided via SoR from the following lists. (1) All forbidden lists maintained by the UE for PLMNs. (2) All forbidden lists maintained by the UE for SNPNs (including onboarding SNPNs). (3) All forbidden lists maintained by the UE for Hosting Networks (including onboarding SNPNs).

The removal of the networks from the forbidden lists maintained by the UE will ensure that the home network provided networks as part of the slice aware SoR information (e.g. PLMNs) are considered by the UE for network selection purpose i.e. camping/registration and access to desired services. The slice-aware SoR information shall have precedence over the local information maintained by the UE i.e. the PLMNs which are part of the Slice-aware SoR information shall not be considered forbidden any more by the UE.

In summary, addressing Issue 3, the UE may handle forbidden lists on reception of slice-aware SoR information. In the solution to Issue #3, the UE may perform the following.

Steps for the UE may include: On reception of the slice-aware SoR information the UE may remove the networks provided via SoR from the following forbidden lists maintained at the UE. (a) All forbidden lists maintained by the UE for PLMNs. (b) All forbidden lists maintained by the UE for SNPNs (including onboarding SNPNs). (c) All forbidden lists maintained by the UE for Hosting Networks (including onboarding SNPNs).

### Proposed Solution to Issue #4

Provisioning of the slice aware SoR information to the SNPNs/Hosting network? In one aspect, a proposed requirement is considered for enhancement of the information available to the UE in roaming scenarios regarding the availability of network slices in VPLMNs available in the roaming country, in order to allow the UE to select and obtain services from the VPLMN supporting the network slices which the UE may wish to use.

The requirement mentions VPLMN, however the UE could be served by SNPNs (home or roaming), Hosting Networks and as such this requirement shall be extended to SNPNs and Hosting Networks as well.

The UE may indicate to the network, in a 5GMM Capability Information of a Registration Request, that the UE is able to receive and understand the “Support for Slice-Aware SoR Information for PLMNs/SNPNs/Hosting Networks”. The benefit of sending such an indication is that the network would be aware of whether the UE understands the new information element. Otherwise, the information would be discarded by a non-supporting UE without the network being aware that the information was discarded.

The network may respond with “Support for Slice-Aware SoR Information for PLMNs/SNPNs/Hosting Networks” in the REGISTRATION ACCEPT message or other NAS signaling messages, including this new information as part of the 5GS network feature support IE.

The UE may explicitly request the “Slice-Aware SoR Information for PLMNs/SNPNs/Hosting Networks” from the network. For example, after the UE receives a rejected/partially rejected S-NSSAI in a Registration Accept or a Registration Reject message, PDU Session Establishment Reject message, the UE may send a NAS Message to the network requesting that the network send to the UE, PLMN/access technology combination(s) that can be used to access the rejected S-NSSAI. The NAS message may be an UL NAS Transport Message or a (mobility) Registration Request message.

If the UE's USIM is configured to receive “Slice-Aware SoR Information for PLMNs/SNPNs/Hosting Networks”, the UE may, during a Registration Procedure, e.g., an initial or mobility Registration procedure, determine its 5GMM Capability to receive and understand the “Slice-Aware SoR Information for PLMNs/SNPNs/Hosting Networks” transparent container, based on its USIM configuration.

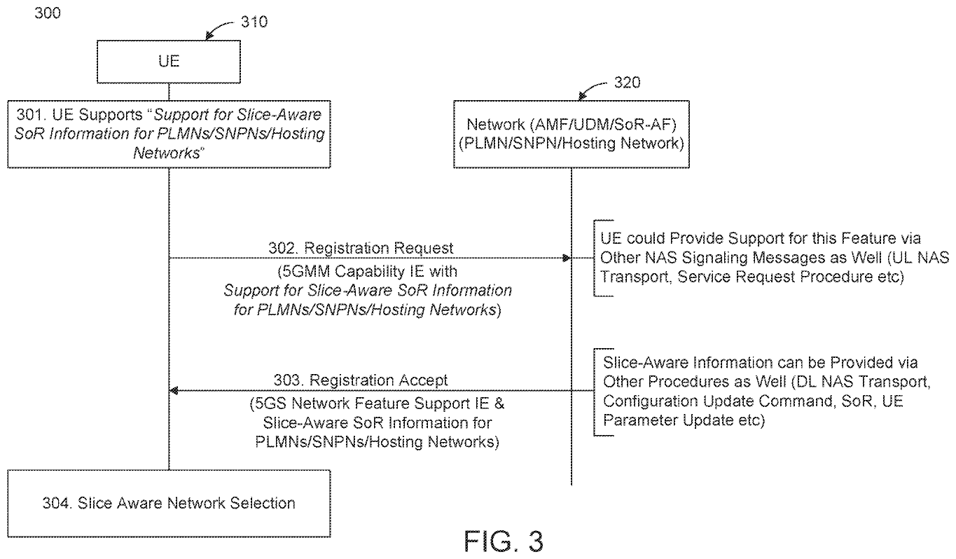

FIG. 3 is a signal flow diagram 300 depicting example Slice-aware SoR Information for PLMNs/SNPNs/Hosting Networks.

At step 301, the UE (310) supports the feature for reception of the Slice-aware SoR Information for PLMNs/SNPNs/Hosting Networks from the network.

At step 302, the UE sends REGISTRATION REQUEST message to the AMF (320) indicating in 5GMM Capability information element IE Support for Slice-aware SoR Information for PLMNs/SNPNs/Hosting Networks. UE could use other NAS/MM procedures as well to inform the network i.e., UL NAS Transport, Service Request Procedure, Mobility Registration etc.

At step 303, the AMF responds with REGISTRATION ACCEPT message including Slice-aware SoR Information for PLMNs/SNPNs/Hosting Networks and 5GS network feature support IE with Support for Slice-aware SoR Information for PLMNs/SNPNs/Hosting Networks set as true. Other NAS procedures could be used as well to provide information e.g., DL NAS Transport, Configuration update command, SoR, UE Parameter Update procedure etc. AMF may coordinate with the SoR-AF to get the required information on the Slice-aware SoR Information for PLMNs/SNPNs/Hosting Networks.

At step 304, the UE uses the received Slice-aware SoR Information for PLMNs/SNPNs/Hosting Networks for the slice aware network selection taking into consideration the required slices by the UE and corresponding preferred list of PLMNs/SNPNs/Hosting Networks. The determination of the required slices is based on receiving a message that S-NSSAI is a rejected S-NSSAI or based on information from an application.

In summary to the solution of Issue #4, the UE may provision the slice aware SoR information to the SNPNs/Hosting network? In the solution to Issue #4, the UE may perform the following.

Steps taken by the UE may include: First, if the UE Supports the feature for reception of the Slice-aware SoR Information for PLMNs/SNPNs/Hosting Networks from the network. UE sends REGISTRATION REQUEST message to the AMF indicating in 5GMM Capability IE Support for Slice-aware SoR Information for PLMNs/SNPNs/Hosting Networks. UE could use other NAS/MM procedures as well to inform the network i.e., UL NAS Transport, Service Request Procedure, Mobility Registration etc.

Second, AMF responds with REGISTRATION ACCEPT message including Slice-aware SoR Information for PLMNs/SNPNs/Hosting Networks. Other NAS procedures could be used as well to provide information e.g., DL NAS Transport, Configuration update command, SoR, UE Parameter Update procedure etc. AMF may coordinate with the SoR-AF to get the required information on the Slice-aware SoR Information for PLMNs/SNPNs/Hosting Networks.

Third, the UE uses the received Slice-aware SoR Information for PLMNs/SNPNs/Hosting Networks for the slice aware network selection taking into consideration the required slices by the UE and corresponding preferred list of PLMNs/SNPNs/Hosting Networks. The determination of the required slices is based on receiving a message that S-NSSAI is a rejected S-NSSAI or based on information from an application.

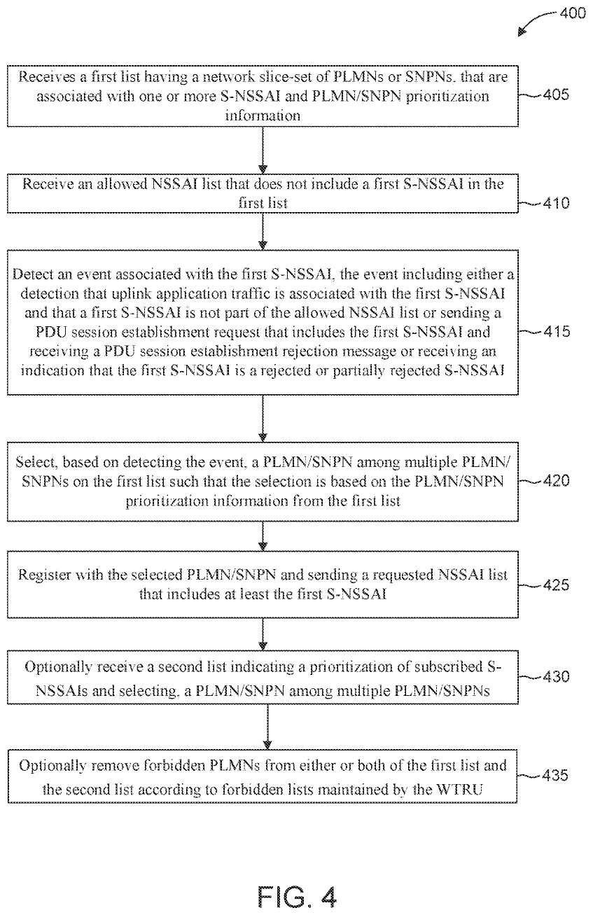

FIG. 4 is a flow diagram of a method 400 incorporating aspects of the solutions addressing the issues described hereinabove. FIG. 4 depicts and example method 400 for a WTRU/UE to perform a public land mobile network (PLMN) selection procedure to select one PLMN among multiple PLMNs which includes single-network slice selection assistance information (S-NSSAI) wherein the selection is based on the prioritization information.

At 405, the WTRU (UE) receives a first list, the first list including a network slice-set of preferred public land mobile networks (PLMN)s or stand-alone non-public networks (SNPN)s, the first list associated with one or more single-network slice selection assistance information (S-NSSAI) and PLMN/SNPN prioritization information.

At 410, the WTRU receives an allowed NSSAI list that does not include a first S-NSSAI in the first list.

At 415, the WTRU detects an event associated with the first S-NSSAI, the event including one of (i) a detection that uplink application traffic is associated with the first S-NSSAI and that a first S-NSSAI is not part of the allowed NSSAI list, or (ii) sending a protocol data unit (PDU) Session Establishment Request that includes the first S-NSSAI and receiving a PDU Session Establishment Rejection message or receiving an indication that the first S-NSSAI is a rejected S-NSSAI or partially rejected S-NSSAI.

At 420, the WTRU selects, based on detecting the event, a PLMN/SNPN among multiple PLMN/SNPNs on the first list. The selection is based on the PLMN/SNPN prioritization information from the first list.

At 425, the WTRU registers with the selected PLMN/SNPN and sends a requested NSSAI list that includes at least the first S-NSSAI. The WTRU may also optionally, at 430, receive a second list, where the second list indicates a prioritization of subscribed S-NSSAIs. The WTRU may then select, based on detecting the event, a PLMN/SNPN from among multiple PLMN/SNPNs. The multiple derived from either or both the first list and the second list.

The second list may include a list from a UDM/UDR. The second list may be a modified version of a list of prioritized subscribed S-NSSAIs that is received from a UDM/UDR. The modified version of the second list of prioritized subscribed S-NSSAIs may be determined by the WTRU using one or more of: (i) the WTRU determines to initially include slices from a Configured NSSAI in the second list, (ii) the WTRU determines to modify the second list such that S-NSSAIs from the Configured NSSAI are always prioritized over S-NSSAIs that are not in the Configured NSSAI, (iii) the WTRU determines to modify the second list by increasing priority of any S-NSSAI that is associated with an established PDU Session, (iv) the WTRU determines to modify the second list by increasing a priority of any S-NSSAI that is associated with a PDU Session Establishment Reject Message, and/or (v) the WTRU determines to modify the second list by increasing a priority of any S-NSSAI that is associated with application traffic and where the WTRU has determined, based on user route selection policy rule evaluation, that there is no suitable Established PDU Session that can carry application traffic and no new PDU Session can be established to carry the application traffic.

At 435, the WTRU may also optionally, remove forbidden PLMNs from either or both of the first list and the second list according to forbidden lists maintained by the WTRU. PLMNs may be removed by identifying PLMNs in forbidden lists of PLMNs maintained by the WTRU for PLMNs, forbidden lists maintained by the WTRU for SNPNs, and forbidden lists maintained by the WTRU for Hosting Networks.

### Conclusion

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, 16 or means-plus-function claim format, and any claim without the terms “means for” is not so intended.

1-15. canceled

16. A method performed by a wireless transmit/receive unit (WTRU), the method comprising:
receiving a first list indicating a plurality of networks, network priority information associated with the plurality of networks, and one or more single network slice selection assistance information (S-NSSAIs) associated with each network of the plurality of networks;
receiving slice priority information associated with one or more subscribed S-NSSAIs;
receiving a second list indicating one or more allowed NSSAIs excluding a first S-NSSAI;
detecting an event associated with the first S-NSSAI;
selecting, based on the network priority information and the slice priority information, a network from the plurality of networks;
registering with the selected network; and
sending, to the selected network, a third list indicating a plurality of requested NSSAIs including at least the first S-NSSAI.

17. The method of claim 16, wherein the plurality of networks include at least one of:
one or more public land mobile networks (PLMNs), or
one or more standalone non-public networks (SNPNs).

18. The method of claim 17, wherein the event comprises at least one of:
detecting uplink application traffic associated with the first S-NSSAI, sending a protocol data unit (PDU) session establishment request including the first S-NSSAI,
receiving a rejection associated with the first S-NSSAI, or
receiving an indication that the first S-NSSAI is rejected or partially rejected.

19. The method of claim 16, wherein the slice priority information is received from a unified data management (UDM) or a unified data repository (UDR).

20. The method of claim 19, further comprising:
determining one or more prioritized subscribed S-NSSAIs from the one or more subscribed S-NSSAIs.

21. The method of claim 20, wherein determining the one or more prioritized subscribed S-NSSAIs comprises one or more of:
including one or more S-NSSAIs from a configured NSSAI,
prioritizing one or more S-NSSAIs from the configured NSSAI over one or more S-NSSAIs not in the configured NSSAI,
increasing a priority of one or more S-NSSAIs associated with an established PDU session,
increasing a priority of one or more S-NSSAIs associated with a rejected PDU session request, or
increasing the priority of one or more S-NSSAIs associated with an application traffic, wherein no suitable PDU session exists or no suitable PDU session can be established to carry the application traffic.

22. The method of claim 16, further comprising:
removing, based on a forbidden list maintained by the WTRU, one or more forbidden networks from the first list. Applicant: InterDigital Patent Holdings, Inc. Application No.: Not Yet Known

23. The method of claim 22, wherein removing the one or more forbidden networks comprises at least one of:
removing one or more forbidden PLMNs comprised in one or more forbidden lists maintained by the WTRU for a plurality of PLMNs,
removing one or more forbidden SNPNs comprised in one or more forbidden lists maintained by the WTRU for a plurality of SNPNs, or
removing the one or more forbidden networks comprised in one or more forbidden lists maintained by the WTRU for a plurality of hosting networks.

24. A wireless transmit/receive unit (WTRU), comprising:
a transceiver; and
a processor, wherein the transceiver and the processor are configured to:
receive a first list indicating a plurality of networks, network priority information associated with the plurality of networks, and one or more single network slice selection assistance information (S-NSSAIs) associated with each network of the plurality of networks,
receive slice priority information associated with one or more subscribed S-NSSAIS,
receive a second list indicating one or more allowed NSSAIs excluding a first S-NSSAI,
detect an event associated with the first S-NSSAI,
select, based on the network priority information and the slice priority information, a network from the plurality of networks,
register with the selected network, and
send, to the selected network, a third list indicating a plurality of requested NSSAIs including at least the first S-NSSAI.

25. The WTRU of claim 24, wherein the plurality of networks includes at least one of:
one or more public land mobile networks (PLMNs), or
one or more standalone non-public networks (SNPNs).

26. The WTRU of claim 25, wherein the event comprises at least one of:
detecting uplink application traffic associated with the first S-NSSAI,
sending a protocol data unit (PDU) session establishment request including the first S-NSSAI,
receiving a rejection associated with the first S-NSSAI, or receiving an indication that the first S-NSSAI is rejected or partially rejected.

27. The WTRU of claim 24, wherein the slice priority information is received from a unified data management (UDM) or a unified data repository (UDR).

28. The WTRU of claim 27, wherein the transceiver and the processor are further configured to:
determine one or more prioritized subscribed S-NSSAIs from the one or more subscribed S-NSSAIs.

29. The WTRU of claim 28, wherein determining the one or more prioritized subscribed S-NSSAIs comprises one or more of:
including one or more S-NSSAIs from a configured NSSAI,
prioritizing one or more S-NSSAIs from the configured NSSAI over one or more S-NSSAIs not in the configured NSSAI,
increasing a priority of one or more S-NSSAIs associated with an established PDU session,
increasing a priority of one or more S-NSSAIs associated with a rejected PDU session request, or
increasing the priority of one or more S-NSSAIs associated with an application traffic, wherein no suitable PDU session exists or no suitable PDU session can be established to carry the application traffic.

30. The WTRU of claim 24, wherein the transceiver and the processor are further configured to:
remove, based on a forbidden list maintained by the WTRU, one or more forbidden networks from the first list.

31. The WTRU of claim 30, wherein removing the one or more forbidden networks comprises at least one of:
removing one or more forbidden PLMNs comprised in one or more forbidden lists maintained by the WTRU for a plurality of PLMNs,
removing one or more forbidden SNPNs comprised in one or more forbidden lists maintained by the WTRU for a plurality of SNPNs, or
removing the one or more forbidden networks comprised in one or more forbidden lists maintained by the WTRU for a plurality of hosting networks.
